(19) United States
(12) Patent Application Publication
(10) Pub. No.: US 2026/0322116 A1
(43) Pub. Date: Oct. 15, 2026

(54) METHOD FOR SUPPRESSING COMMUTATION FAILURE BASED ON REACTIVE POWER FEEDBACK CONTROL IN HYBRID CASCADED HVDC TRANSMISSION SYSTEM, STORAGE MEDIUM, AND ELECTRONIC DEVICE

(71) Applicant: SOUTHWEST JIAOTONG UNIVERSITY, Sichuan (CN)

(72) Inventors: Sheng LIN, Sichuan (CN); Jian LIU, Sichuan (CN); Dalin MU, Sichuan (CN); Zhengyou HE, Sichuan (CN); Lihan XIA, Sichuan (CN)

(73) Assignee: SOUTHWEST JIAOTONG UNIVERSITY, Sichuan (CN)

(21) Appl. No.: 18/998,125

(22) PCT Filed: Dec. 19, 2023
(86) PCT No.: PCT/CN2023/139772

§ 371 Date: Jan. 24, 2025

(30) Foreign Application Priority Data
Dec. 14, 2023 (CN) 202311625270.7

(51) Int. Cl. H02J 3/001; H02J 3/1857; H02J 3/36

(52) U.S. Cl. CPC H02J 3/00125; H02J 3/1857; H02J 3/36

(57) ABSTRACT

Disclosed is a method for suppressing a commutation failure based on a reactive power feedback control in a hybrid cascaded HVDC transmission system, a storage medium, and an electronic device, mainly including as follows: obtaining power data of the hybrid cascaded HVDC transmission system, calculating the reactive power supply amount of the AC system at the MMC terminal on the inverter side, the reactive power supply amount of the AC filter on the inverter side, and the reactive power supply amount of the AC system at the LCC terminal on the inverter side, solving the reactive power control command of the MMC on the inverter side, and determining whether to implement the method for suppressing a commutation failure based on a reactive power feedback control in a hybrid cascaded HVDC transmission system according to the threshold voltage.

### TECHNICAL FIELD

The present disclosure relates to the technical field of high-voltage direct-current power transmission, and in particular to a method for controlling a commutation failure based on a reactive power feedback control in a hybrid cascaded HVDC transmission system, a storage medium, and an electronic device.

### DESCRIPTION OF RELATED ART

The HVDC transmission technology has the advantages such as large delivery capacity, long power transmission distance, and strong control adjustment effect, and is widely applied to power long-distance transmission and regional large-grid interconnection. The HVDC transmission technology rectifies the three-phase AC into DC by the rectifier at the transmitting terminal of the system, transmits the power by using the power transmission line, and then converts the DC into the three-phase AC at the receiving terminal of the system, and sends the electric energy to the AC power grid at the receiving terminal.

Current HVDC transmission technologies are mainly divided into two types: one type of conventional DC transmission based on a line commutated converter (LCC), and the other type of flexible direct-current power transmission based on a modular multilevel converter (MMC). In order to integrate the technical advantages of LCC and MMC, two DC transmission technologies are adopted at the same time in China Baihetan-Jiangsu HVDC transmission engineering, the LCC is adopted at the engineering transmitting terminal, and a structure in which LCC is connected in series with three parallel MMCs is adopted at a receiving terminal. The advantage of the structure is that the MMC converter without commutation failure is adopted at the receiving terminal of the system, so that the commutation failure occurrence probability is greatly reduced; the MMC discharge path is blocked by the LCC after the DC fault, so that the DC fault ride-through capability of the system is enhanced; and the LCC and the three MMCs at the receiving terminal of the system on the inverter side are dispersed and connected to different AC systems, so that the system has a multi-drop-point power receiving capability and a dynamic reactive power support capability, and the operation mode is more flexible.

The commutation failure is a common fault of a HVDC transmission system based on a power grid commutation converter, multiple consecutive commutation failures can lead to a sudden increase in direct current, shorten the service life of the converter valve, or even cause a DC system to be locked, resulting in a large loss of direct-current power, which seriously threatens the security and stability of the power grid system at the receiving terminal. The MMC converter is adopted at the low-voltage terminal of the HVDC transmission system, which does not have the problem of commutation failure, however, the LCC converter is still adopted at the high-voltage terminal of the HVDC transmission system, so the problem of commutation failure can not be ignored.

At present, the suppression measures of commutation failure, such as triggering a converter in advance, reducing direct current, reconstructing a topology structure of a converter, are mostly aimed at conventional LCC DC transmission systems, and have few dedicated commutation failure suppression methods that consider the control and operational characteristics of HVDC transmission systems. Considering the particularity of HVDC transmission structures and the excellent reactive power regulation capability of the MMC converter, further research is required on how to control the reactive power output of MMC converters and utilize MMC converters to suppress commutation failures.

### SUMMARY

Each of the exemplary embodiments of the present disclosure provides a method for controlling a commutation failure based on a reactive power feedback control in a hybrid cascaded HVDC transmission system, a storage medium, and an electronic device, so as to at least implement the technical effects of reducing the occurrence probability of commutation failure by using a MMC to output reactive power to support the AC bus voltage on the inverter side.

Each of the exemplary embodiments of the present disclosure provides a method for controlling a commutation failure based on a reactive power feedback control in a hybrid cascaded HVDC transmission system, including following steps.

Power data of the hybrid cascaded HVDC transmission system are obtained.

A threshold voltage is calculated, and a control intervention calculation is performed in a case where an effective value for an AC bus voltage at an LCC terminal is less than the threshold voltage during a system operation period.

The control intervention calculation includes that a reactive power supply amount of an AC system at an MMC terminal on the inverter side, a reactive power supply amount of an AC filter on the inverter side, a reactive power supply amount of the AC system at an LCC terminal on the inverter side are calculated, and a target MMC reactive power control command on the inverter side is solved.

A reactive power control command of an MMC on the inverter side is adjusted to the target MMC reactive power control command on the inverter side obtained by the control intervention calculation, to control a reactive output of the MMC.

In another aspect of the present disclosure, a computer-readable storage medium is further provided, a computer program is stored in the storage medium, and the computer program is configured to execute the steps in any one of the above methods when operating.

In another aspect of the present disclosure, an electronic device is further provided, the electronic device includes a memory and a processor, a computer program is stored in the memory, and the processor is configured to operate the computer program to execute the steps in any one of the above methods in the embodiments.

The present disclosure has the following beneficial effects. During the normal operation, the reactive power consumed by the converter is provided by the AC filter, and in a case where the AC system is subjected to a large disturbance, the reactive in-situ balance in the steady state of the DC system is broken. By utilizing the MMC reactive power output, the reactive power absorbed by the DC system to the AC system on the inverter side can be reduced, the drop degree of the bus voltage is reduced, and the risk of subsequent commutation failure of the hybrid cascaded system is reduced.

The feedback of reactive measurement actually measured value in the AC system at the LCC terminal on the inverter side is introduced in the present disclosure, so that reactive power closed-loop control of the inverter side is implemented, and the method for suppressing the commutation failure based on the MMC reactive power support in the hybrid cascaded HVDC transmission system is purposed, so that the occurrence probability of commutation failure of the hybrid cascaded HVDC transmission system is effectively reduced.

The reactive power supply amount of the AC system at the MMC terminal on the inverter side is considered by the method for suppressing the commutation failure based on the reactive power feedback control, so that the reactive power provided by the AC system at the MMC terminal can be reduced in the transient state, the voltage reduction of the AC system at the MMC terminal is avoided, the blocking phenomenon of MMC power transmission is eliminated, and the overvoltage of the MMC is suppressed.

The present disclosure is simple in calculation and clear in physical significance, does not require to change the structure and the hardware of the hybrid cascaded HVDC transmission system, and can implement the contents of the present disclosure through simple arithmetic operations merely based on the existing electrical quantity and control quantity parameters of the HVDC system, with low requirements for hardware and software, as well as high calculation speed, and is suitable for field engineering applications.

### BRIEF DESCRIPTION OF THE DRAWINGS

The drawings described herein are used to provide a further understanding on the present disclosure and constitute one part of the present disclosure, and the illustrative embodiments of the present disclosure and the descriptions thereof are used to explain the present disclosure, and do not constitute an improper limitation on the present disclosure. In the drawings:

FIG. 1 illustrates a schematic diagram of an overall process of the present disclosure.

FIG. 2 illustrates a simulation diagram of a commutation failure suppression effect of an original control method in a system under a three-phase fault in one specific embodiment of the present disclosure.

FIG. 3 illustrates a simulation diagram of a commutation failure suppression effect of a commutation failure suppression method based on MMC reactive power PI regulation under a three-phase fault in one specific embodiment of the present disclosure.

FIG. 4 illustrates a simulation diagram of a commutation failure suppression effect of a control method in the present disclosure under a three-phase fault in one specific embodiment of the present disclosure.

FIG. 5 illustrates a schematic structural diagram of an optional electronic device in an embodiment of the present disclosure.

### DESCRIPTION OF THE EMBODIMENTS

The technical solutions in the embodiments of the present disclosure are described clearly and completely with reference to the accompanying drawings in the preferred embodiments of the present disclosure. Obviously, the described embodiments are one part of the present disclosure, not all of the embodiments in the present disclosure. All other embodiments obtained by a person of ordinary skill in the art based on the embodiments of the present disclosure without creative labor shall fall within the protection scope of the present disclosure.

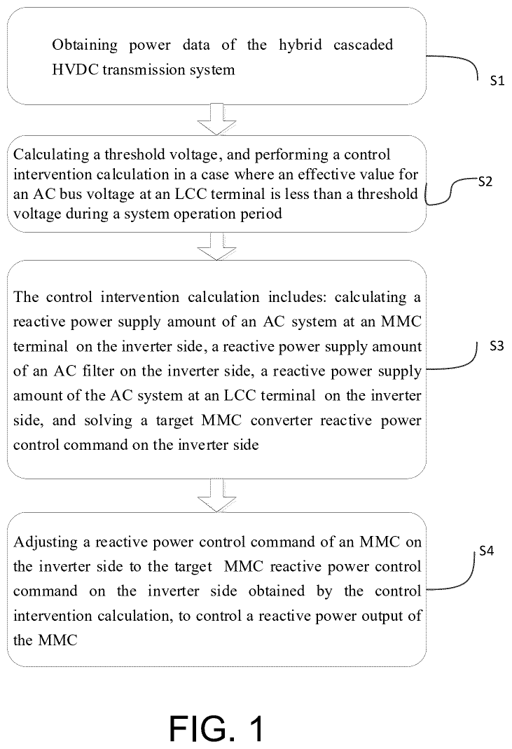

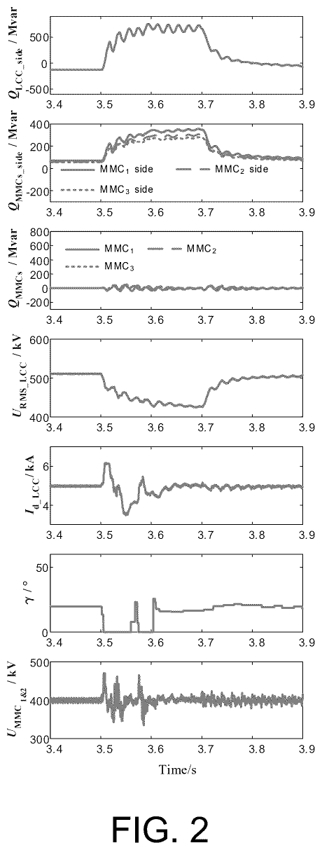

As illustrated in FIG. 1 and FIG. 2, provided is a method for suppressing a commutation failure based on a reactive power feedback control in a hybrid cascaded HVDC transmission system, including following steps.

In S1, power data of the hybrid cascaded HVDC transmission system are obtained.

In S2, a threshold voltage is calculated, and a control intervention calculation is performed in a case where an effective value for an AC bus voltage at an LCC terminal is less than the threshold voltage during the system operation period.

In S3, the control intervention calculation includes that a reactive power supply amount of an AC system at an MMC terminal on the inverter side, a reactive power supply amount of an AC filter on the inverter side, a reactive power supply amount of the AC system at an LCC terminal on the inverter side are calculated, so that a target MMC reactive power control command on the inverter side is obtained.

In S4, a reactive power control command of an MMC on the inverter side is adjusted to the target MMC reactive power control command on the inverter side obtained by the control intervention calculation, to control a reactive output of the MMC.

In an optional implementation, as illustrated in FIG. 1, the step of obtaining power data of the hybrid cascaded HVDC transmission system in Step 1 includes in the following.

The three-phase voltage instantaneous values uₐ, u_{b} and u_{c} for the AC bus at the LCC terminal on the inverter side of the system, three-phase current instantaneous values iₐ, i_{b} and i_{c} for the AC bus at the LCC terminal on the inverter side of the system, an effective value U_{LL} for an AC bus voltage, a drop value ΔUₗ for the AC bus voltage at the LCC terminal after an AC fault, an extinction angle of the inverter γ, a DC current I_{d}, and a DC power P_{d} are real-timely collected by a control and protection device of the hybrid cascaded HVDC transmission system with a sampling frequency f Hz.

In an optional implementation, the step of calculating a threshold voltage, and performing, in a case where an effective value for an AC bus voltage at an LCC terminal is less than the threshold voltage, a control intervention calculation during a system operation period in Step S2 includes in the following.

The threshold voltage Uₜₕ, is calculated, and a calculation formula is expressed as follows:

$${U}_{t h} = {U}_{N} \sqrt{\frac{{cos}^{2} {γ}_{N} - {cos}^{2} {β}_{N}}{{cos}^{2} {γ}_{min} - {cos}^{2} {β}_{N}}} ,$$

where U_{N} denotes a rated value for the AC bus voltage on the inverter side during steady-state operation of a system, γₘᵢₙ denotes a critical extinction angle of the inverter, γ_{N} denotes a rated value for an extinction angle of the LCC inverter, and β_{N} denotes a rated value for a advance firing angle.

When the system is operating, whether the effective value U_{LL} for the AC bus voltage of the LCC terminal is less than the threshold voltage Uₜₕ is determined. If yes, the control input signal 1 is output, and Step S3 is entered; if no, the control input signal 0 is output, and Step S2 is returned to.

In an optional implementation, in Step S3, the step of calculating the reactive power supply amount of the AC system at the MMC terminal on the inverter side, the reactive power supply amount of the AC filter on the inverter side, the reactive power supply amount of the AC system at the LCC terminal on the inverter side, to obtain the target MMC reactive power control command on the inverter side includes in the following.

In S3.1, a reactive power supply amount of the AC system at an MMC; terminal on an inverter side is calculated, where j=1, 2, 3, which denotes different MMC converters, and firstly a drop value ΔUⱼ for the AC bus voltage at the MMCⱼ terminal on the inverter side is calculated by the control and protection device, and a calculation formula is expressed as follows:

$$Δ {U}_{j} = Δ {U}_{l} \cdot \vert \frac{{Z}_{j}}{{Z}_{lj} + {Z}_{j}} \vert ,$$

where Zₗⱼ and Zⱼ respectively denote a contact impedance of an AC bus connected to the MMCⱼ terminal on the inverter side and an AC bus connected to the LCC terminal on the inverter side, as well as an equivalent impedance of AC system at the MMCⱼ terminal, and ΔUₗ denotes the drop value for the AC bus voltage at the LCC terminal after the AC fault.

In S3.2, a reactive power Δ Q_{acj} provided by the AC system at the MMC terminal on the inverter side is calculated, and a calculation formula is expressed as follows:

$$Δ {Q}_{acj} = \frac{Δ {U}_{j}}{{U}_{Nj}} {S}_{acj} ,$$

where U_{Nj} denotes a rated value for the AC bus connected to MMCⱼ terminal during a normal operation, and S_{acj} denotes a short-circuit capacity of the AC system at the MMCⱼ terminal.

In S3.3, a reactive power supply amount of an AC filter on the inverter side is calculated, that is, the reactive power Q_{f} provided by an AC filter on the inverter side is calculated according to an effective value U_{LL} for the AC bus voltage at the LCC terminal, and a calculation formula is expressed as follows:

$${Q}_{f} = {B}_{f} {U}_{L L}^{2} ,$$

where Bᵢ denotes an equivalent susceptance of the AC filter.

In S3.4, a reactive power supply amount of an AC system at the LCC terminal on the inverter side is calculated, physical quantities corresponding to instantaneous values for three-phase voltages and instantaneous values for three-phase currents of an AC bus at the LCC terminal on the inverter side under a dq coordinate system are firstly solved, and calculation formulas for the three-phase voltages and a current dq transformation are expressed as follows:

$$[ \begin{matrix}{u}_{d} \\ {u}_{q} \\ {u}_{0}\end{matrix} ] = \sqrt{\frac{2}{3}} [ \begin{matrix}cos ω t & cos ( ω t - 120 ° ) & cos ( ω t + 120 ° ) \\ - sin ω t & - sin ( ω t - 120 ° ) & - sin ( ω t + 120 ° ) \\ 1 / 2 & 1 / 2 & 1 / 2\end{matrix} ] [ \begin{matrix}{u}_{a} \\ {u}_{b} \\ {u}_{c}\end{matrix} ] ,$$

$$[ \begin{matrix}{i}_{d} \\ {i}_{q} \\ {i}_{0}\end{matrix} ] = \sqrt{\frac{2}{3}} [ \begin{matrix}cos ω t & cos ( ω t - 120 ° ) & cos ( ω t + 120 ° ) \\ - sin ω t & - sin ( ω t - 120 ° ) & - sin ( ω t + 120 ° ) \\ 1 / 2 & 1 / 2 & 1 / 2\end{matrix} ] [ \begin{matrix}{i}_{a} \\ {i}_{b} \\ {i}_{c}\end{matrix} ] .$$

In S3.5, the reactive power supply amount Q_{acm} of an AC system at the LCC terminal on the inverter side is calculated, and a calculation formula is expressed as follow:

$${Q}_{a c m} = {u}_{q} {i}_{d} - {u}_{d} {i}_{q} .$$

In S3.6, a reactive power control command Q_{MMCrefj} of an MMCⱼ on the inverter side is calculated and a calculation formula is expressed as follows:

$${Q}_{MMCrefj} = \frac{1}{3} [ {Q}_{d} - {Q}_{f} - ( {Q}_{acref} - {Q}_{a c m} - {\sum }_{j = 1}^{n} Δ {Q}_{acj} ) ] ( j = 1 , 2 , 3 ; n = 3 ) ,$$

where Q_{d} denotes a reactive power consumed by the converter, Q_{acref} denotes a reference value for the reactive power control command, and a calculation formula for Q_{d} is as follows:

$${Q}_{d} = {P}_{d} \sqrt{{( \frac{\frac{3 \sqrt{2} N {U}_{L L}}{k π} cos γ - \frac{3 N {X}_{r} {I}_{d}}{π}}{\frac{3 \sqrt{2} N {U}_{L L}}{k π}} )}^{2} - 1} ,$$

where N denotes the number of 6-pulse converters on the inverter side, U_{LL} denotes an effective value for the AC bus voltage, k denotes a transformation ratio of a converter transformer, Xr denotes a leakage reactance of the converter transformer, γ denotes an inverter extinction angle, I_{d} denotes a DC current, and P_{d} denotes a DC power.

It should be noted that the principle of the control intervention calculation in Step S3 is as follows.

During the normal operation, the reactive power consumed by the converter is provided by the AC filter, and in a case where the AC system is subjected to a large disturbance, the reactive in-situ balance in the steady state of the DC system is broken. By utilizing the MMC reactive power output, the reactive power absorbed by the DC system to the AC system on the inverter side can be reduced, the drop degree of the bus voltage is reduced, and the risk of subsequent commutation failure of the hybrid cascaded system is reduced. Therefore, the design principle of the calculation formula for Q_{d} is as follows.

Specifically, the reactive power consumption in the transient state of the converter can be calculated by the following formula:

$$\{ \begin{matrix}{Q}_{d} = {P}_{d} tan φ = {P}_{d} \sqrt{{( \frac{{U}_{d}}{{U}_{d 0}} )}^{2} - 1} \\ {U}_{d} = \frac{3 \sqrt{2} N {U}_{L L}}{k π} cos γ - \frac{3 N {X}_{r} {I}_{d}}{π} \\ {U}_{d 0} = \frac{3 \sqrt{2} N {U}_{L L}}{k π}\end{matrix} ,$$

where N denotes the number of 6-pulse converters on the inverter side, U_{LL} denotes an effective value for the AC bus voltage, k denotes a transformation ratio of a converter transformer, Xr denotes a leakage reactance of the converter transformer, γ denotes an inverter extinction angle, I_{d} denotes a DC current, and P_{d} denotes a DC power, U_{d} denotes the DC voltage, U_{d0} denotes the ideal no-load DC voltage, φ denotes the power factor of the converter.

Then, reactive power supply amount of the AC system at the MMCⱼ terminal (j=1, 2, 3, representing different MMCs) on the inverter side, the reactive power supply amount of the AC filter on the inverter side, and the reactive power supply amount of the AC system at the LCC terminal on the inverter side are calculated, and the reactive power balance relation on the inverter side is constructed as follows:

$${Q}_{d} = 3 \cdot {Q}_{MMCrefj} + {Q}_{f} + ( {Q}_{acref} - {Q}_{a c m} - {\sum }_{j = 1}^{n} Δ {Q}_{acj} ) ( j = 1 , 2 , 3 ; n = 3 ) ,$$

where

$${Q}_{acref} - {Q}_{a c m} - {\sum }_{j = 1}^{n} Δ {Q}_{acj}$$

denotes the differences between the reactive expected value and the actually measured value exchanged between the DC system and the AC system on the inverter side.

Further, the reactive power control command of MMC; converter on the inverter side can be obtained by

$${Q}_{MMCrefj} = \frac{1}{3} [ {Q}_{d} - {Q}_{f} - ( {Q}_{acref} - {Q}_{a c m} - {\sum }_{j = 1}^{n} Δ {Q}_{acj} ) ] ( j = 1 , 2 , 3 ; n = 3 ) .$$

Further, according to the real-time voltage and the critical voltage of the AC bus, whether the reactive power control command of MMCⱼ converter on the inverter side is required to be input is determined, and in a case where the condition of Step S4 is satisfied, the reactive power control command of the MMCⱼ converter on the inverter side is adjusted to the obtained reactive power control command Q_{MMCrefj} of the MMCⱼ converter, and the reactive power output of the MMC converter is controlled to implement the commutation failure suppression.

In an optional implementation, a value for the sampling frequency f ranges from 10 k to 100 k.

In an optional implementation, a value for the critical extinction angle γₘᵢₙ is 7 or 10. It should be noted that the critical extinction angle is a fixed value, and has a clear and definite physical significance; and a value refers to the engineering experience.

In an optional implementation, the reference value Q_{acref} for the reactive power control command refers to a value for the DC system during a stable operation and the value is artificially set, and the value in this embodiment is 0.

The following uses a specific embodiment of the present disclosure for illustration.

In Step A, power data of the hybrid cascaded HVDC transmission system are obtained.

The three-phase voltage instantaneous values uₐ, u_{b} and u_{c} for the AC bus at the LCC terminal on the inverter side of the system, three-phase current instantaneous values iₐ, i_{b} and i_{c} for the AC bus at the LCC terminal on the inverter side of the system, an effective value U_{LL} for an AC bus voltage, a drop value ΔUₗ for the AC bus voltage at the LCC terminal after an AC fault, an extinction angle gamma of the inverter γ, a DC current I_{d}, and a DC power P_{d} are real-timely collected by a control and protection device of the hybrid cascaded HVDC transmission system with a sampling frequency f HZ.

In Step B1, the threshold voltage Uₜₕ, is calculated, and a calculation formula is expressed as follows:

$${U}_{t h} = {U}_{N} \sqrt{\frac{{cos}^{2} {γ}_{N} - {cos}^{2} {β}_{N}}{{cos}^{2} {γ}_{min} - {cos}^{2} {β}_{N}}} ,$$

where U_{N} denotes a rated value for the AC bus voltage on the inverter side during steady-state operation of a system, γₘᵢₙ denotes a critical extinction angle of the inverter, γ_{N} denotes a rated value for an extinction angle of the LCC inverter, and β_{N} denotes a rated value for a advance firing angle.

In Step B2, when the system is operating, whether the effective value U_{LL} for the AC bus voltage of the LCC terminal is less than the threshold voltage Uₜₕ is determined. If yes, the control input signal 1 is output, and Step C is entered; if no, the control input signal 0 is output, and the Step B2 is returned to.

In Step C, a reactive power supply amount of the AC system at an MMCⱼ terminal on an inverter side is calculated, (j=1, 2, 3, which denotes different MMCs).

Firstly a drop value ΔUⱼ for the AC bus voltage drop at the MMCⱼ terminal on the inverter side is calculated by the control and protection device, and a calculation formula is expressed as follows:

$$Δ {U}_{j} = Δ {U}_{l} \cdot \vert \frac{{Z}_{j}}{{Z}_{lj} + {Z}_{j}} \vert ,$$

where Zₗⱼ and Zⱼ respectively denote a contact impedance of an AC bus connected to the MMCⱼ terminal on the inverter side and an AC bus connected to the LCC terminal on the inverter side, as well as an equivalent impedance of AC system at the MMCⱼ terminal AC system, and ΔUₗ denotes the drop value for the AC bus voltage at the LCC terminal after the AC fault.

Next, a reactive power Δ Q_{acj} provided by the AC system at the MMCⱼ terminal on the inverter side is calculated, and a calculation formula is expressed as follows:

$$Δ {Q}_{acj} = \frac{Δ {U}_{j}}{{U}_{Nj}} {S}_{acj} ,$$

where U_{Nj} denotes a rated value for the AC bus connected to MMCⱼ terminal during a normal operation, and Sacj denotes a short-circuit capacity of the AC system at the MMCⱼ terminal.

In Step D, a reactive power supply amount of an AC filter on the inverter side is calculated.

The reactive power Q_{f} provided by the AC filter on the inverter side is calculated according to an effective value U_{LL} for the AC bus voltage at the LCC terminal, and a calculation formula is expressed as follows:

$${Q}_{f} = {B}_{f} {U}_{L L}^{2} ,$$

where B_{f} denotes an equivalent susceptance of the AC filter.

In Step E, a reactive power supply amount of an AC system at the LCC terminal on the inverter side is calculated.

Physical quantities corresponding to instantaneous values for three-phase voltages and instantaneous values for three-phase currents of an AC bus at the LCC terminal on the inverter side under a dq coordinate system are firstly solved, and calculation formulas for the three-phase voltages and a current dq transformation are expressed as follows:

$$[ \begin{matrix}{u}_{d} \\ {u}_{q} \\ {u}_{0}\end{matrix} ] = \sqrt{\frac{2}{3}} [ \begin{matrix}cos ω t & cos ( ω t - 120 ° ) & cos ( ω t + 120 ° ) \\ - sin ω t & - sin ( ω t - 120 ° ) & - sin ( ω t + 120 ° ) \\ 1 / 2 & 1 / 2 & 1 / 2\end{matrix} ] [ \begin{matrix}{u}_{a} \\ {u}_{b} \\ {u}_{c}\end{matrix} ] ,$$

$$[ \begin{matrix}{i}_{d} \\ {i}_{q} \\ {i}_{0}\end{matrix} ] = \sqrt{\frac{2}{3}} [ \begin{matrix}cos ω t & cos ( ω t - 120 ° ) & cos ( ω t + 120 ° ) \\ - s in ω t & - sin ( ω t - 120 ° ) & - sin ( ω t + 120 ° ) \\ 1 / 2 & 1 / 2 & 1 / 2\end{matrix} ] [ \begin{matrix}{i}_{a} \\ {i}_{b} \\ {i}_{c}\end{matrix} ] .$$

Then, the reactive power supply amount Q_{acm} of an AC system at the LCC terminal on the inverter side is calculated, and a calculation formula is expressed as follows:

$${Q}_{a c m} = {u}_{q} {i}_{d} - {u}_{d} {i}_{q} .$$

In Step F, a reactive power control command of an MMCⱼ on the inverter side is calculated.

In conjunction with the reactive power supply amount of the AC system at the MMCⱼ terminal on the inverter side, the reactive power supply amount of the AC filter on the inverter side, the reactive power supply amount of the AC system at the LCC terminal on the inverter side obtained by Steps C, D, and E, a reactive power control command Q_{MMCrefj} of the MMCⱼ inverter on the inverter side is calculated and a calculation formula is expressed as follow:

$${Q}_{MMCrefj} = \frac{1}{3} [ {Q}_{d} - {Q}_{f} - ( {Q}_{acref} - {Q}_{a c m} - {\sum }_{j = 1}^{n} Δ {Q}_{acj} ) ] ( j = 1 , 2 , 3 ; n = 3 ) ,$$

where Q_{d} denotes a reactive power consumed by the converter, Q_{acref} denotes a reference value for the reactive power control command, and a calculation formula for Q_{d} is as follows:

$${Q}_{d} = {P}_{d} \sqrt{{( \frac{\frac{3 \sqrt{2} N {U}_{L L}}{k π} cos γ - \frac{3 N {X}_{r} {I}_{d}}{π}}{\frac{3 \sqrt{2} N {U}_{L L}}{k π}} )}^{2} - 1} ,$$

where N denotes the number of 6-pulse converters on the inverter side, U_{LL} denotes an effective value for the AC bus voltage, k denotes a transformation ratio of a converter transformer, Xr denotes a leakage reactance of the converter transformer, γ denotes an inverter extinction angle, I_{d} denotes a DC current, and P_{d} denotes a DC power.

In Step G, the reactive power control command of the MMCⱼ converter on the inverter side is adjusted to the obtained reactive power control command Q_{MMCref} of the MMCⱼ converter in Step F, and the reactive power output of the MMC converter is controlled.

In this embodiment, for example, the value for sampling frequency f is 10 k in Step A, a value for the critical extinction angle γₘᵢₙ is 7° in Step B1, the reference value Q_{acref} for the reactive power control command is 0 in Step F.

### Simulation Experiment

In order to verify the effects that the proposed control method reduces the commutation failure of the HVDC transmission system, a HVDC transmission electromagnetic transient simulation model based on a Baihetan-Jiangsu DC power transmission project in China is built on the PSCAD/EMTDC software platform, an inductive grounding fault is set at the AC bus on the inverter side, and the less the grounding inductance, the more serious the fault. The suppression effects of the following three control methods on commutation failure are compared and analyzed: 1) the original control method of the system; 2) the method for suppressing commutation failure based on MMC reactive power PI regulation; 3) the method of the present disclosure.

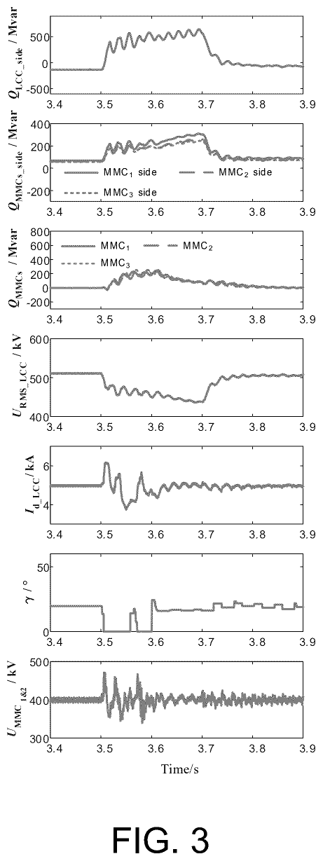

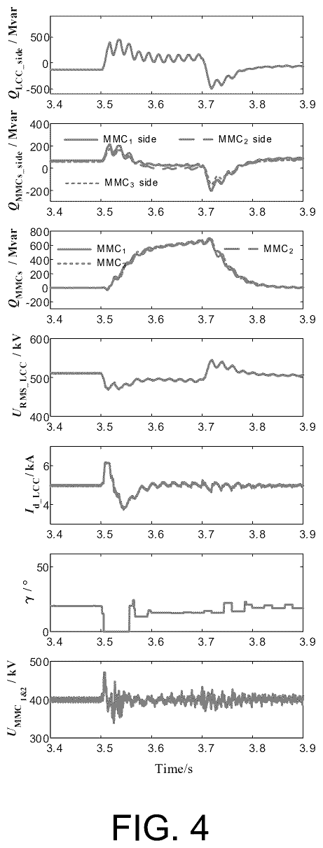

The three-phase ground short-circuit fault with the most serious fault severity is selected to verify the commutation failure suppression effects of the three methods. As illustrated in FIG. 2 to FIG. 4, effects of the three methods are compared under a three-phase ground short-circuit fault. The electrical quantities from top to bottom are: the reactive power provided by the AC system at the LCC terminal, the reactive power provided by the AC system at the MMC terminal, the reactive power of the MMC output, the effective value for the commutation bus voltage at the LCC terminal, the DC current of the DC system, the LCC extinction angle, and MMC DC voltage in sequence. It can be seen that, due to the increase of reactive power consumption of the LCC converter after the fault, the bus voltage is continuously dropped, causing subsequent commutation failure and resulting in MMC overvoltage in original method. The commutation failure suppression method based on MMC reactive power PI regulation can provide partial reactive power to support the bus voltage, but due to the inability of the reactive power supply amount to match the reactive power requirement of the system, subsequent commutation failures still occur in the system. The method of the present disclosure adopts the idea of reactive power feedback control to suppress commutation failure, implements transient reactive power supply balance on the inverter side, reduces the drop degree of AC bus voltage, and thus suppresses subsequent commutation failures.

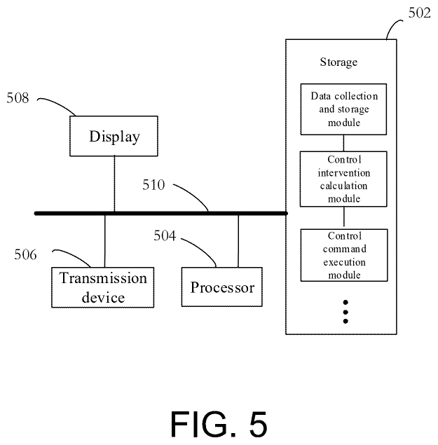

According to still another aspect of the embodiments of the present disclosure, further provided is an electronic device for implementing the method for suppressing a commutation failure based on a reactive power feedback control in a hybrid cascaded HVDC transmission system, the electronic device may be, but is not limited to, applied to a server. As illustrated in FIG. 5, the electronic device includes a memory 502 and a processor 504, and a computer program is stored in the memory 502, and the processor 504 is configured to perform the steps in any one of the above method embodiments by using a computer program.

Optionally, in this embodiment, the electronic device can be located in at least one of a plurality of network devices in a computer network.

Optionally, in this embodiment, the processor can be configured to perform the following steps by using a computer program.

In S1, power data of the hybrid cascaded HVDC transmission system are obtained.

In S2, a threshold voltage is calculated, and a control intervention calculation is performed in a case where an effective value for an AC bus voltage of an LCC terminal is less than a threshold voltage during the system operation period.

In S3, the control intervention calculation includes that a reactive power supply amount of an AC system at an MMC terminal on the inverter side, a reactive power supply amount of an AC filter on the inverter side, a reactive power supply amount of the AC system at an LCC terminal on the inverter side are calculated, and a target MMC converter reactive power control command on the inverter side solving is solved.

In S4, a reactive power control command of an MMC on the inverter side is adjusted to the target MMC reactive power control command on the inverter side obtained by the control intervention calculation, to control a reactive output of the MMC.

Optionally, an ordinary technician in the art may understand that the structure illustrated in FIG. 5 is merely illustrative, and the electronic device may be a terminal device such as a mobile Internet device (MID) or a PAD. FIG. 5 does not define the structure of the electronic device. For example, the electronic device may further include more or fewer components (such as a network interface) than those illustrated in FIG. 5, or have a configuration different from that illustrated in FIG. 5.

The memory 502 may include a high-speed random access memory, and may further include a non-volatile memory, for example, one or more magnetic storage devices, a flash memory, or another non-volatile solid-state memory. In a plurality of instances, the memory 502 may further include memories remotely disposed relative to the processor 504, and these remote memories may be connected to the terminal through a network. Instances of the above network include, but are not limited to, the Internet, an intranet, a local area network, a mobile communication network, and combinations thereof. As an exemplification, as illustrated in FIG. 5, the memory 502 may include, but is not limited to, a storage module, an alarm module, and the like, and details are not described herein again in this exemplification.

Optionally, the transmission device 506 is configured to receive or send data via a network. Specific instances of the network may include a wired network and a wireless network. In one instance, the transmission device 506 includes a network interface controller (NIC), which may be connected to other network devices through a network cable and a router so as to communicate with the Internet or a local area network. In one instance, the transmission device 506 is a radio frequency (RF) module, which is configured to communicate with the Internet in a wireless manner.

In addition, the electronic device further includes: a display 508, configured to display a current simulation result; and a connection bus 510, configured to connect each module component in the electronic device.

An embodiment of the present disclosure further provides a computer-readable storage medium, and a computer program is stored in the storage medium, and when the computer program is set to operate, the steps in any one of the above method embodiments are executed.

Optionally, in this embodiment, the storage medium may be configured to store a computer program for performing the following steps.

In S1, power data of the hybrid cascaded HVDC transmission system are obtained.

In S2, a threshold voltage is calculated, and a control intervention calculation is performed in a case where an effective value for an AC bus voltage of an LCC terminal is less than a threshold voltage during the system operation period.

In S3, the control intervention calculation includes that a reactive power supply amount of an AC system at an MMC terminal on the inverter side, a reactive power supply amount of an AC filter on the inverter side, a reactive power supply amount of the AC system at an LCC terminal on the inverter side are calculated, and a target MMC reactive power control command on the inverter side is solved.

In S4, a reactive power control command of an MMC on the inverter side is adjusted to the target MMC reactive power control command on the inverter side obtained by the control intervention calculation, to control a reactive output of the MMC.

Optionally, the storage medium is further configured to store a computer program for executing the steps included in the method in the above embodiments, and details are not described herein again in this embodiment.

Optionally, in this embodiment, an ordinary technician in the art may understand that all or parts of the steps in the methods in the above embodiments may be completed by instructing, by a program, hardware related to the terminal device, where the program may be stored in a computer-readable storage medium, and the storage medium may include: a flash disk, a Read-Only Memory (ROM), a Random Access Memory (RAM), a magnetic disk, an optical disk, or the like.

The sequence numbers of the above embodiments of the present disclosure are merely for descriptions, and do not represent the advantages and disadvantages of the embodiments.

When the integrated unit in the above embodiments is implemented in the form of a software functional unit and sold or used as an independent product, the integrated unit may be stored in the above computer-readable storage medium. Based on such understanding, the technical solution of the present disclosure essentially or all or part of the technical solution that contributes to the prior art may be embodied in the form of a software product, and the computer software product is stored in a storage medium, and includes a plurality of commands for enabling one or more computer devices (which may be a personal computer, a server, a network device, and the like) to perform all or part of the steps of the methods described in the embodiments of the present disclosure.

In the above embodiments of the present disclosure, the descriptions of each embodiment have its own emphasis, and parts which are not described in detail in an embodiment may refer to related descriptions of other embodiments.

In the embodiments provided in the present disclosure, it should be understood that the disclosed client may be implemented in other manners. The device embodiments described above are merely illustrative, for example, the division of the units is merely a logical function division, and there may be other division manners in actual implementation, for example, a plurality of units or components may be combined or may be integrated into another system, or a plurality of features may be ignored or not performed. In addition, the displayed or discussed mutual coupling or direct coupling or communication connection may be indirect coupling or communication connection through some interfaces, units or modules, and may be electrical or other forms.

The units described as separate parts may or may not be physically separate, and parts displayed as units may or may not be physical units, may be located in one position, or may be distributed on a plurality of network units. Parts or all of the units may be selected according to actual requirements to achieve the objectives of the solutions of the embodiments.

In addition, functional units in the embodiments of the present disclosure may be integrated into one processing unit, or each of the units may exist alone physically, or two or more units are integrated into one unit. The integrated unit may be implemented in a form of hardware, or may be implemented in a form of a software functional unit.

The above are merely preferred implementations of the present disclosure, and it should be noted that, for an ordinary technician in the art, a plurality of improvements and modifications may be made without departing from the principle of the present disclosure, and these improvements and modifications should also be considered as the protection scope of the present disclosure

Although the preferred embodiments of the present disclosure are described, a person skilled in the art can make additional changes and modifications according to these embodiments once they learn the basic inventive concept. Therefore, the appended claims are intended to be interpreted as including the preferred embodiments and all changes and modifications falling within the scope of the present disclosure.

Finally, it should be noted that the above embodiments are merely used to illustrate the technical solutions of the present disclosure and are not limited thereto; although the present disclosure are described in detail with reference to the above embodiments, it should be understood by an ordinary technician in the art that the above embodiments may still modify the technical solutions described in the above embodiments, or equivalently replace parts of the technical features therein; and these modifications or replacements do not make the essence of the corresponding technical solutions separate from the spirit and scope of the technical solutions of the embodiments of the present disclosure.

1. A method for suppressing a commutation failure based on a reactive power feedback control in a hybrid cascaded high voltage direct current (HVDC) transmission system, comprising following steps:
obtaining power data of the hybrid cascaded HVDC transmission system;
calculating a threshold voltage, and performing, in a case where an effective value for an alternating current (AC) bus voltage at a line commutated converter (LCC) terminal is less than the threshold voltage, a control intervention calculation during a system operation period; wherein
the control intervention calculation comprises:
calculating a reactive power supply amount of an AC system at a modular multilevel converter (MMC) terminal on an inverter side, a reactive power supply amount of an AC filter on the inverter side, a reactive power supply amount of the AC system at an LCC terminal on the inverter side, and solving a target MMC reactive power control command on the inverter side, and
adjusting a reactive power control command of an MMC on the inverter side to the target MMC reactive power control command on the inverter side obtained by the control intervention calculation, to control a reactive power output of the MMC,
wherein a step of obtaining the power data of the hybrid cascaded HVDC transmission system comprises:
real-timely collecting, by a control and protection device of the hybrid cascaded HVDC transmission system with a sampling frequency f HZ, three-phase voltage instantaneous values uₐ, u_{b} and u_{c} for the AC bus at the LCC terminal on the inverter side of the system, three-phase current instantaneous values iₐ, i_{b} and i_{c} for the AC bus at the LCC terminal on the inverter side of the system, an effective value U_{LL} for the AC bus voltage, a drop value ΔUₗ for the AC bus voltage at the LCC terminal after an AC fault, an extinction angle of the inverter γ, a DC current I_{d}, and a DC power P_{d},
wherein a step of calculating the threshold voltage comprises:
calculating the threshold voltage Uₜₕ, and expressing a calculation formula as:
$${U}_{th} = {U}_{N} \sqrt{\frac{{cos}^{2} {γ}_{N} - {cos}^{2} {β}_{N}}{{cos}^{2} {γ}_{min} - {cos}^{2} {β}_{N}}} ,$$
where U_{N} denotes a rated value for the AC bus voltage on the inverter side during a steady-state operation of the system, γₘᵢₙ denotes a critical extinction angle of the inverter, γ_{N} denotes a rated value for an extinction angle of the LCC inverter, and β_{N} denotes a rated value for an advance firing angle; and
a step for the control intervention calculation of calculating the reactive power supply amount of the AC system at the MMC terminal on the inverter side, the reactive power supply amount of the AC filter on the inverter side, the reactive power supply amount of the AC system at the LCC terminal on the inverter side, and solving the target MMC reactive power control command on the inverter side comprises:
calculating a reactive power supply amount of the AC system at an MMC terminal on the inverter side, where j=1, 2, 3, which denotes different MMCs, and firstly calculating a drop value ΔUⱼ for the AC bus voltage at the MMCⱼ terminal on the inverter side by the control and protection device, and expressing a calculation formula as:
$$Δ {U}_{j} = Δ {U}_{l} \cdot \vert \frac{{Z}_{j}}{{Z}_{lj} + {Z}_{j}} \vert ,$$
where Zₗⱼ and Zⱼ respectively denote a contact impedance of an AC bus connected to the MMCᵢ terminal on the inverter side and an AC bus connected to the LCC terminal on the inverter side, as well as an equivalent impedance of the AC system at the MMCᵢ terminal, and ΔUₗ denotes the drop value for the AC bus voltage at the LCC terminal after the AC fault;
calculating a reactive power ΔQ_{acj} provided by the AC system at the MMCⱼ terminal on the inverter side, and expressing a calculation formula as:
$$Δ {Q}_{acj} = \frac{Δ {U}_{j}}{{U}_{Nj}} {S}_{acj} ,$$
where U_{Nj}; denotes a rated value for the AC bus connected to the MMCⱼ terminal during a normal operation, and S_{acj} denotes a short-circuit capacity of the AC system at the MMCᵢ terminal;
calculating the reactive power supply amount of the AC filter on the inverter side, that is, calculating, according to an effective value U_{LL} for the AC bus voltage at the LCC terminal, a reactive power Q_{f} provided by the AC filter on the inverter side, and expressing a calculation formula as:
$${Q}_{f} = {B}_{f} {U}_{L L}^{2} ,$$
where B_{f} denotes an equivalent susceptance of the AC filter;
calculating a reactive power supply amount of the AC system at the LCC terminal on the inverter side, firstly solving physical quantities corresponding to instantaneous values for three-phase voltages and instantaneous values for three-phase currents of the AC bus at the LCC terminal on the inverter side under a dq coordinate system, and expressing calculation formulas for the three-phase voltages and a current dq transformation as:
$$[ \begin{matrix}{u}_{d} \\ {u}_{q} \\ {u}_{0}\end{matrix} ] = \sqrt{\frac{2}{3}} [ \begin{matrix}cos ω t & cos ( ω t - 120 ° ) & cos ( ω t + 120 ° ) \\ - sin ω t & - sin ( ω t - 120 ° ) & - sin ( ω t + 120 ° ) \\ 1 / 2 & 1 / 2 & 1 / 2\end{matrix} ] [ \begin{matrix}{u}_{a} \\ {u}_{b} \\ {u}_{c}\end{matrix} ] ,$$
$$[ \begin{matrix}{i}_{d} \\ {i}_{q} \\ {i}_{0}\end{matrix} ] = \sqrt{\frac{2}{3}} [ \begin{matrix}cos ω t & cos ( ω t - 120 ° ) & cos ( ω t + 120 ° ) \\ - s in ω t & - sin ( ω t - 120 ° ) & - sin ( ω t + 120 ° ) \\ 1 / 2 & 1 / 2 & 1 / 2\end{matrix} ] [ \begin{matrix}{i}_{a} \\ {i}_{b} \\ {i}_{c}\end{matrix} ] ,$$
calculating the reactive power supply amount Q_{acm} of the AC system at the LCC terminal on the inverter side, and expressing a calculation formula as:
$${Q}_{a c m} = {u}_{q} {i}_{d} - {u}_{d} {i}_{q} .$$
and
calculating a reactive power control command Q_{MMCrefj} of an MMCⱼ converter on the inverter side and expressing a calculation formula as:
$${Q}_{MMCrefj} = \frac{1}{3} [ {Q}_{d} - {Q}_{f} - ( {Q}_{acref} - {Q}_{a c m} - {\sum }_{j = 1}^{n} Δ {Q}_{acj} ) ] ( j = 1 , 2 , 3 ) ,$$
where Q_{d} denotes a reactive power consumed by the converter, Q_{acref} denotes a reference value for the reactive power control command, and a calculation formula for Q_{d} is expressed as:
$${Q}_{d} = {P}_{d} \sqrt{{( \frac{\frac{3 \sqrt{2} N {U}_{L L}}{k π} cos γ - \frac{3 N {X}_{r} {I}_{d}}{π}}{\frac{3 \sqrt{2} N {U}_{L L}}{k π}} )}^{2} - 1} ,$$
where N denotes a number of 6-pulse converters on the inverter side, U_{LL} denotes an effective value for the AC bus voltage, k denotes a transformation ratio of a converter transformer, Xr denotes a leakage reactance of the converter transformer, γ denotes an inverter extinction angle, I_{d} denotes a DC current, and Pa denotes a DC power.

2-4. (canceled)

5. The method for suppressing the commutation failure based on the reactive power feedback control in the hybrid cascaded HVDC transmission system according to claim 1, wherein a value for the sampling frequency f ranges from 10 k to 100 k.

6. The method for suppressing the commutation failure based on the reactive power feedback control in the hybrid cascaded HVDC transmission system according to claim 1, wherein a value for the critical extinction angle γₘᵢₙ is 7 or 10.

7. The method for suppressing the commutation failure based on the reactive power feedback control in the hybrid cascaded HVDC transmission system according to claim 1, wherein the reference value Q_{acref} for the reactive power control command refers to a value for the DC system during a stable operation and the value is artificially set.

8. A computer-readable storage medium, wherein a computer program is stored in the storage medium, and the computer program is configured to execute the method according to claim 1 when operating.

9. An electronic device, comprising a memory and a processor, wherein a computer program is stored in the memory, and the processor is configured to operate the computer program to execute the method according to claim 1.
